(19) United States
(12) Patent Application Publication
(10) Pub. No.: US 2014/0160207 A1
(43) Pub. Date: Jun. 12, 2014

(54) Hybrid-Type Apparatus for Injecting Ink

(71) Applicant: Injet Co., Ltd., Gyeonggi-do (KR)

(72) Inventors: Do-Young Byun, Seoul (KR); Vu Dat Nguyen, Gyeonggi-do (KR)

(73) Assignee: Injet Co., Ltd., Gyeonggi-do (KR)

(21) Appl. No.: 14/074,077

(22) Filed: Nov. 7, 2013

(30) Foreign Application Priority Data
Nov. 7, 2012 (KR) 10-2012-0125585

(51) Int. Cl. B41J 2/045

(52) U.S. Cl. CPC B41J 2/04501
USPC 347/68

(57) ABSTRACT

Provided herein is an apparatus for jetting ink where the upper side of a nozzle is open and a physical actuator is provided, and a physical actuator is driven by an electrode provided on the upper and lower side to form an electric field, thereby becoming capable of easily jetting fine-diameter ink.

### CROSS-REFERENCE TO RELATED APPLICATIONS

This application claims the benefit of priority under 35 U.S.C. §119(a) of Korean Patent Applications No. 10-2012-0125585, filed on Nov. 7, 2012, in the Korean Intellectual Property Office, the entire disclosure of which is incorporated herein by reference for all purposes.

### BACKGROUND

1. Field

The following description relates to an apparatus for jetting ink, for example, an apparatus for jetting ink capable of jetting fine-diameter ink in droplets.

2. Description of Related Art

In general, apparatuses for jetting droplets configured to jet fluid in droplets were applied to inkjet primers in various ways. Recently, developments have been made to apply such apparatuses to high-tech fields such as display process apparatus. print circuit board process apparatus and DNA chip manufacturing process.

For ink jet printers mentioned above, there are thermal type and piezo-electric type apparatuses for jetting ink in droplets.

In such thermal type or piezoelectric type apparatuses, there is a limitation in reducing the size of the droplets being jetted through a nozzle due to the limitation of jetting energy. Not only that, there is a limitation in terms of the viscosity of the liquid that may be jetted through aforementioned apparatuses. In general, it is difficult for aforementioned apparatuses to form and jet droplets of 20 μm or less, or jet 50 cP or more amount of liquid.

In order to resolve such limitations of prior art ink jetting methods, there has been developed an ink jetting apparatus that uses electrostatic force to apply a voltage to an opposed electrode thereby forming an electric field so that ink may be jetted from the nozzle.

Especially, an apparatus has been suggested as a fine control method for jetting droplets in certain cycles. In such an apparatus, surface of the droplets are controlled using a physical control apparatus such as a piezoelectric actuator etc. and droplets are jetted using electrostatic force.

FIG. 1 is an example of a conventional ink jetting apparatus configured to use electrostatic force.

That is, with reference to FIG. 1, in a conventional apparatus for jetting ink, them is provided inside a nozzle an electrode 13 that is configured to be applied with a voltage to form an electric field between the electrode 13 and the opposed electrode 14, and droplets are jetted through a physical actuator disposed on a top end of the nozzle 11.

However, a conventional apparatus for jetting ink 10 that uses electrostatic force illustrated in FIG. 1 has the following problems or disadvantages to be overcome.

That is, in a conventional method for jetting ink, an electrode 13 that applies electrostatic force is disposed inside a nozzle 11, and thus the actual process is complicated and the connection to a power controller is not easy.

In addition, there is required an additional membrane structure for transmitting the vibration generated in a physical actuator 12 disposed on a top end of the nozzle to the liquid, and thus failures occur in the membrane process.

Furthermore, the process of adhering the physical actuator to the top end of the membrane structure is very complicated, and in this process membrane may be destructed. In addition, in a conventional apparatus, there is a burden of having to provide a high voltage applying apparatus 16 and a control apparatus 15 for forming an electric field between the control apparatus 15 that controls high voltage applied on the upper and lower side of the physical actuator and the nozzle 11.

### SUMMARY

Therefore, a purpose of the present disclosure is to provide an apparatus for jetting ink where the upper side of a nozzle is open and a physical actuator is provided, and a physical actuator is driven by an electrode provided on the upper and lower side to form an electric field, thereby becoming capable of easily jetting fine-diameter ink.

In one general aspect, there is provided an apparatus for jetting ink, the apparatus comprising: a nozzle for accommodating ink, with an opening formed on one end, and a nozzle tip formed on another end for jetting the ink; a physical actuator comprising a piezoelectric actuator provided on the opening, an upper electrode provided on an upper side of the piezoelectric actuator to be applied with a voltage for driving the piezoelectric actuator, and a membrane electrode provided on a lower side of the piezoelectric actuator such that it faces inside of the nozzle, and applying physical pressure inside the nozzle; an opposed electrode disposed outside the nozzle, and being applied with a voltage forming an electric field between the opposed electrode and the membrane electrode; and a voltage applier applying a voltage to the opposed electrode and physical actuator.

In the general aspect of the apparatus, the membrane electrode may be applied with a greater voltage from the voltage applier than the voltage applied to the opposed electrode so that a potential difference is generated between the opposed electrode.

In the general aspect of the apparatus, the apparatus may further comprise a gate electrode disposed such that it surrounds a nozzle tip on the nozzle.

In the general aspect of the apparatus, the opposed electrode may be disposed on an opposite surface of a surface facing the nozzle of the substrate.

In the general aspect of the apparatus, a voltage having a pulse voltage superposed on the voltage applied to the membrane electrode may be applied to the upper electrode.

In the general aspect of the apparatus, a direct or alternating voltage may be applied to the membrane electrode and the opposed electrode.

According to the present disclosure, there is provided an apparatus for jetting ink when an upper side of the nozzle is open, and there is no additional membrane but a physical actuator is provided to be used as a membrane.

In addition, according to the present disclosure, by using the electrode disposed on a lower side of the physical actuator as a common electrode for driving the piezoelectric actuator and forming an electric field, it becomes possible to easily jet fine-diameter droplets.

Furthermore, by disposing a gate electrode surrounding a nozzle tip, it is possible to prevent the electric field formed between the substrate and nozzle being affected by noise from outside.

Other features and aspects may be apparent from the following detailed description, the drawings, and the claims.

### BRIEF DESCRIPTION OF THE DRAWINGS

FIG. 1 is an example of a conventional droplet jetting apparatus using electrostatic force.

FIG. 2 to FIG. 4 are schematic views of an apparatus for jetting ink according to an exemplary embodiment of the present disclosure.

FIG. 5 is a schematic view of a modified exemplary embodiment of an apparatus for jetting ink of FIG. 2.

FIG. 6 to FIG. 9 are schematic views of different forms of a voltage applied to each electrode of an apparatus for jetting ink of FIG. 2.

FIG. 10 to FIG. 13 are schematic views of a voltage applied to each electrode of an apparatus for jetting ink according to a modified exemplary embodiment of FIG. 2.

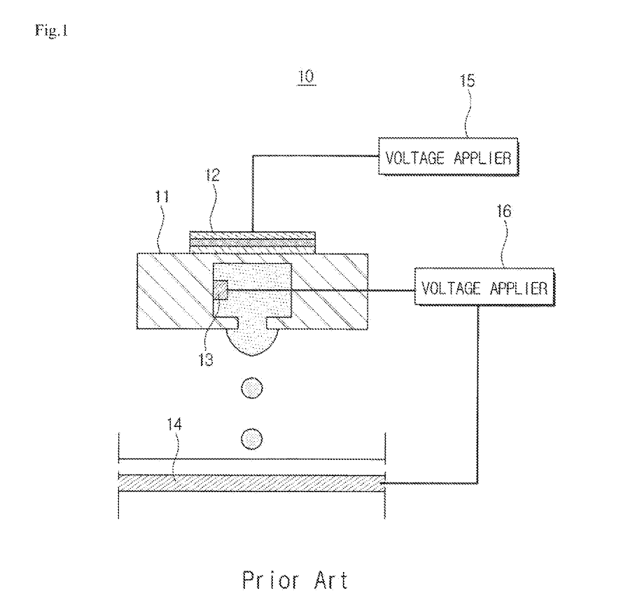

Throughout the drawings and the detailed description, unless otherwise described, the same drawing reference numerals will he understood to refer to the same elements, features, and structures. The relative size and depiction of these elements may be exaggerated for clarity, illustrating, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

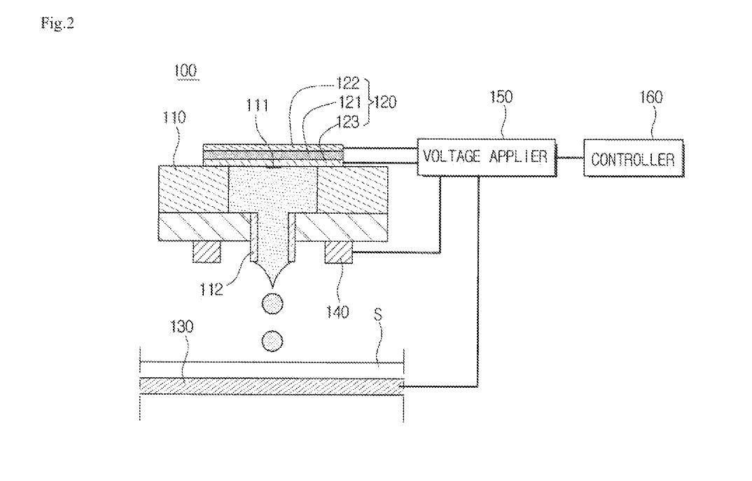

FIG. 2 to FIG. 4 are schematic views of an apparatus for jetting ink according to an exemplary embodiment of the present disclosure.

With reference to FIG. 2 to FIG. 4, an apparatus for jetting ink according to an exemplary embodiment of the present disclosure 100 is an apparatus with a simplified structure, comprising a nozzle 110, physical actuator 120, opposed electrode 130, gate electrode 140, voltage applier 150, and controller, wherein an electrode where voltage is applied, is used as a membrane.

The nozzle 110 is for using jetting ink, and there is provided a predetermined space for accommodating ink inside the nozzle 110. In addition, on the top end, there is provided an opening 111 so that a physical actuator 120 for adjusting inner pressure may be disposed, while on the lower end, there is provided a nozzle tip 112 for jetting ink.

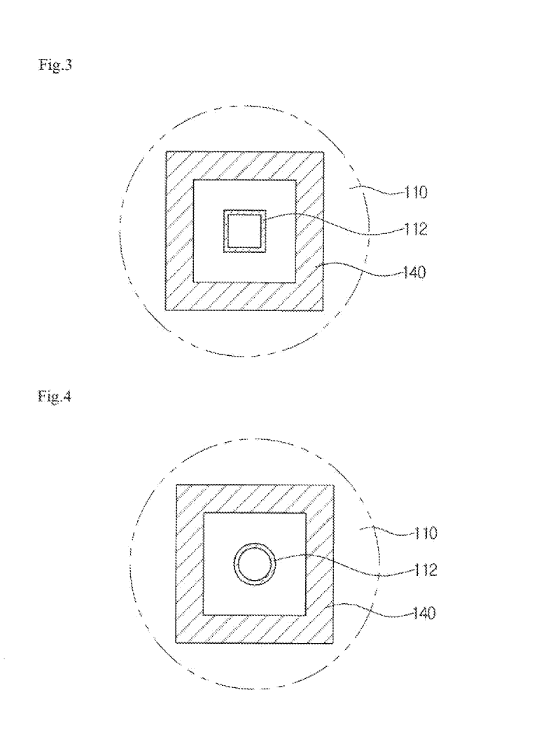

Meanwhile, the size area and shape of the opening 111 at the top end of the nozzle 110 are determined in consideration of the size area of the physical actuator 120. In addition, in the present exemplary embodiment, the cross-section of the nozzle tip 112 provided on the lower end of the nozzle 110 may be circular as in FIG. 3 or square as in FIG. 4, but the cross-section of the nozzle tip is not limited thereto, but may be determined in consideration of the diameter of the ink droplets being jetted.

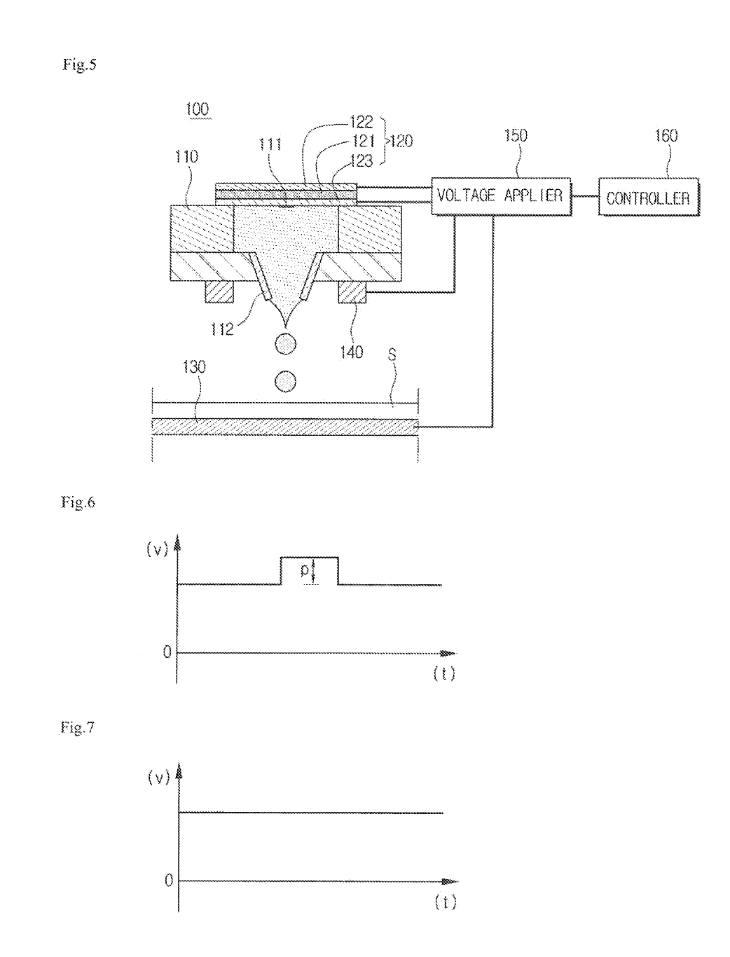

FIG. 5 is a schematic view of a modified exemplary embodiment of an apparatus for jetting ink of FIG. 2.

In addition, in the present exemplary embodiment, the nozzle tip 112 is extended from the lower end surface of the nozzle 110, but as illustrated in FIG. 5, according to the modified exemplary embodiment, the farther away from the lower end surface of the nozzle 110, the nozzle tip 112 may be sloped with its width becoming narrower.

The physical actuator 120 is for physically adjusting the pressure inside the aforementioned nozzle 110. The physical actuator 120 is provided on the top end of the opening 111 of the nozzle 110, and comprises a piezoelectric actuator 121, upper electrode 122, and membrane electrode 123.

The piezoelectric actuator 121 is a plate-shaped piezo device for converting electrical energy into physical energy and is disposed between the upper electrode 122 to be explained hereinbelow and the membrane electrode 123.

The upper electrode 122 is for being applied with a voltage for driving the piezoelectric actuator 121 together with the lower electrode 123. It is a thin film electrode provided on the upper side of the piezoelectric actuator 121.

The membrane electrode 123 is a thin film electrode configured to be applied with a voltage together with the upper electrode 122, convert the voltage into physical energy together with the piezoelectric actuator 121 to press the space inside the nozzle 110, and form a potential difference between the membrane electrode 123 and the opposed electrode 130 with the voltage applied.

Therefore, the physical actuator 120 having a 3-layer structure of a piezoelectric actuator 121, upper electrode 122, and membrane electrode 123 closes the opening 111 of the nozzle 110 to prevent leakage of ink, and causes physical conversion to press the space inside the nozzle 110 thereby increasing the pressure. At the same time, by the voltage applied as the piezoelectric actuator 121 is driven, a potential difference occurs between the membrane and the opposed electrode 130. This will be explained in more detail hereinbelow.

The opposed electrode 130 is an electrode provided on the opposite side of the surface of the substrate S facing the nozzle 110, and is applied with a voltage by the voltage applier 150 and forms a potential difference between the opposed electrode 130 and the membrane electrode 123.

The gate electrode 140 is an electrode provided on the nozzle 110 to surround the nozzle tip 112. It is an electrode for protecting the electric field generated between the membrane 123 and the opposed electrode 130.

Meanwhile, the location of the opposed electrode 130 is not limited to the present exemplary embodiment as long as it forms an electric field between the membrane electrode 123 and the opposed electrode 130, that is between the nozzle 110 and the substrate S.

The voltage applier 150 applies a voltage to the aforementioned upper electrode 122 of the physical actuator 120 and membrane electrode 123, and the opposed electrode 130 and gate electrode 140.

The controller 160 is connected to the voltage applier 150 and controls the conditions such as the voltage amount, format, and timing etc. of the voltage applied to each electrode.

Hereinbelow is explanation on an operation of an exemplary embodiment of the aforementioned apparatus for jetting ink.

FIG. 6 to FIG. 9 are schematic views of different forms of a voltage applied to each electrode of an apparatus for jetting ink of FIG. 2 to FIG. 4.

First of all, ink is supplied inside the nozzle 110, the controller 160 controls the voltage applier 150 to apply a voltage to the gate electrode 140 and opposed electrode 130 and the membrane electrode 123 of the physical actuator 120.

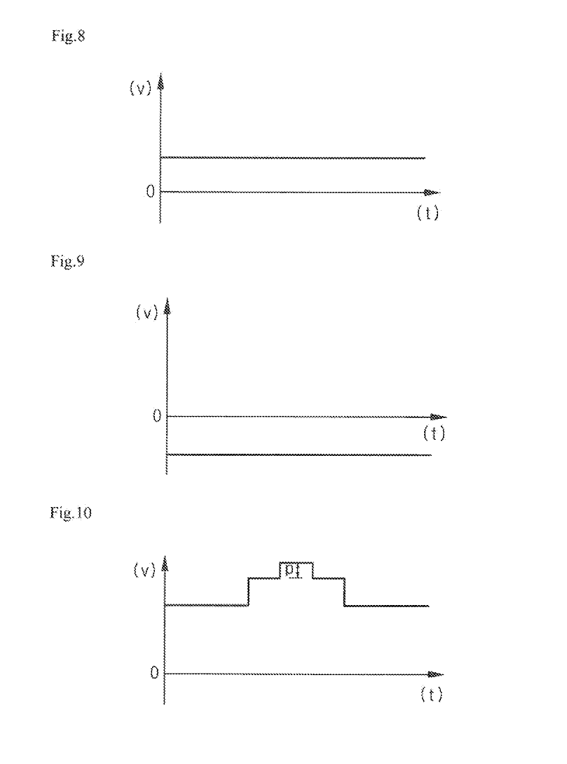

Herein, with reference to FIG. 6 to FIG. 9, a different voltage is applied to each electrode. That is, a greater DC voltage is applied the membrane electrode 123 as FIG. 7 compared to the DC voltage applied to the gate electrode 140 in FIG. 8, and the direct voltage applied to the opposed 130 as in FIG. 9.

By the electric field formed between the membrane electrode 123 provided on the opening 111 of the nozzle 110 and the opposed electrode 130 provided on a lower side of the substrate S, the ink inside the nozzle is pushed towards the substrate S, the ink forming a meniscus on the nozzle tip 112.

In addition, with a meniscus formed by the ink on the nozzle tip 112, the controller 160 applies a greater voltage to each electrode, forming a greater potential difference between the nozzle 110 and the substrate S, and the ink forms a Taylor's Cone on the end portion of the nozzle tip 112.

At the same time, the controller 160 controls the pulse voltage p to be applied to the upper electrode 122 from the voltage applier 150 so as to drive the physical actuator 120. Herein, as illustrated in FIG. 6, a voltage having a pulse voltage p superposed on the voltage applied to the membrane electrode 123 is applied to the upper electrode 122.

With the voltage applied to the membrane 123, when a pulse voltage p is applied to the upper electrode 122, the piezoelectric actuator 121 contacting the upper electrode 123 is physically converted, and the membrane electrode 123 mounted on the lower end of the piezoelectric actuator 121 is also physically converted thereby pressing the inside of the nozzle 110.

The pressure inside of the nozzle 110 that is pressed by the membrane electrode 123 increases, pushing the ink accommodated inside the nozzle 110 towards the nozzle tip 112, and the ink forming a Taylor's Cone on the end portion of the nozzle tip 112 by the aforementioned operating principle is taken off from the Taylor's Cone, thereby being jetted in droplets to the substrate S.

That is, the timing when the ink droplets are jetted from the nozzle may be controlled by controlling the timing of the pulse voltage p applied to the upper electrode 122.

Meanwhile, as aforementioned, when a voltage is applied to the gate electrode 140 from the voltage applier 150, the gate electrode 140 protects the electric field formed between the membrane electrode 123 and the opposed electrode 130 from the noise outside.

Therefore, according to the present exemplary embodiment, without having to add an electrode for forming an electric field, the membrane electrode 123 is used as an electrode to form an electric field and also as a common electrode for driving the physical actuator 120, thereby saving production cost and providing an easily processible apparatus for jetting ink.

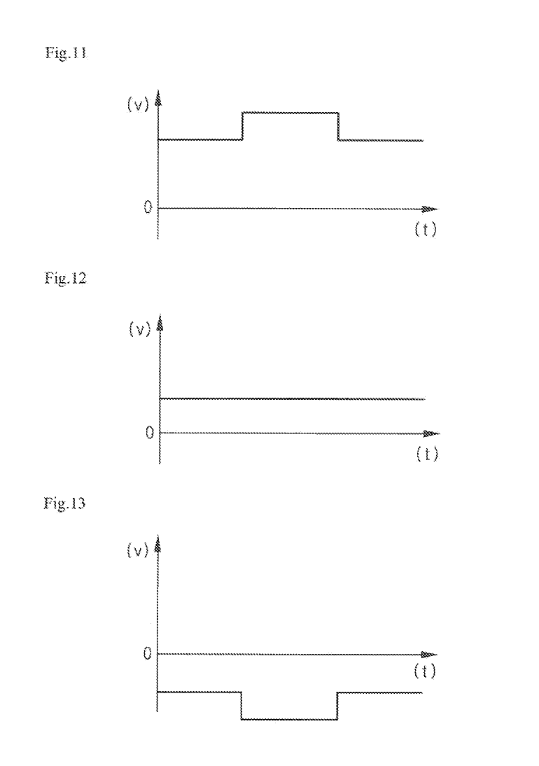

FIG. 10 to FIG. 13 are schematic views of a voltage applied to each electrode of an apparatus for jetting ink according to a modified exemplary embodiment of FIG. 2.

In the present exemplary embodiment, a direct voltage is applied to the opposed electrode 130 and membrane electrode 123, but as illustrated in FIG. 10 to FIG. 13, in the modified exemplary embodiment, the controller 160 controls the voltage applier 150 so that an alternating voltage may be applied to the membrane electrode 123 (FIG. 11) and the opposed electrode 130 (FIG. 13), and that a voltage having a pulse voltage p superposed on the voltage applied to the membrane electrode 123 applied to the upper electrode 122 (FIG. 10).

A number of examples have been described above. Nevertheless, it will be understood that various modifications may he made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

### DESCRIPTION OF REFERENCE NUMERALS

110: NOZZLE

120: PHYSICAL ACTUATOR

130: OPPOSED ELECTRODE

140: GATE ELECTRODE

150: VOLTAGE APPLIER

160: CONTROLLER

What is claimed is:

1. An apparatus for jetting ink, the apparatus comprising:
a nozzle for accommodating ink, with an opening formed on one end, and a nozzle tip formed on another end for jetting the ink;
a physical actuator comprising a piezoelectric actuator provided on the opening, an upper electrode provided on an upper side of the piezoelectric actuator to be applied with a voltage for driving the piezoelectric actuator, and a membrane electrode provided on a lower side of the piezoelectric actuator such that it faces inside of the nozzle, and applying physical pressure inside the nozzle;
an opposed electrode disposed outside the nozzle, and being applied with a voltage forming an electric field between the opposed electrode and the membrane electrode; and
a voltage applier applying a voltage to the opposed electrode and physical actuator.

2. The apparatus according to claim 1,
wherein the membrane electrode is applied with a greater voltage from the voltage applier than the voltage applied to the opposed electrode so that a potential difference is generated between the opposed electrode.

3. The apparatus according to claim 2,
further comprising a gate electrode disposed such that it surrounds a nozzle tip on the nozzle.

4. The apparatus according to claim 3,
wherein he opposed electrode is disposed on an opposite surface of a surface facing the nozzle of the substrate.

5. The apparatus according to claim 4,
wherein a voltage having a pulse voltage superposed on the voltage applied to the membrane electrode is applied to the upper electrode.

6. The apparatus according to claim 5,
wherein a direct or alternating voltage is applied to the membrane electrode and the opposed electrode.
